(19) United States
(12) Patent Application Publication
(10) Pub. No.: US 2013/0088603 A1
(43) Pub. Date: Apr. 11, 2013

(54) COMPACT VIEWER FOR INVISIBLE INDICIA

(71) Applicants: Thomas D. Pawlik, Rochester, NY (US); Thomas J. Widzinski, (US); Judith A. Bose, Webster, NY (US); Myra T. Olm, Webster, NY (US)

(72) Inventors: Thomas D. Pawlik, Rochester, NY (US); Thomas J. Widzinski, (US); Judith A. Bose, Webster, NY (US); Myra T. Olm, Webster, NY (US)

(21) Appl. No.: 13/270,260

(22) Filed: Oct. 11, 2011

(51) Int. Cl. H04N 5/33; H04N 5/30

(52) U.S. Cl. 348/164; 348/162; 348/E05.09; 348/E05.085

(57) ABSTRACT

An apparatus for detecting and viewing an invisible indicia includes an illumination source for illuminating the invisible indicia with radiation of a first wavelength; a sensor array for detecting emitted light from the invisible indicia at a second wavelength; a filter between the sensor and the invisible indicia for eliminating reflected radiation at the first wavelength; a lens for focusing an image of the invisible indicia on the sensor array; a video display for displaying the image of the invisible indicia; a spacer for spacing the sensor array at a fixed distance from the invisible indicia; and a gain control for adjusting sensitivity of the sensor array.

### CROSS REFERENCE TO RELATED APPLICATIONS

Reference is made to commonly-assigned copending U.S. patent application Ser. No. ______ (Attorney Docket No. K000638US01RLO), filed herewith, entitled ARTICLE PRINTED WITH INFRARED DYE, by Widzinski et al.; and U.S. patent application Ser. No. ______ (Attorney Docket No. K000625US01NAB), filed herewith, entitled METHOD FOR VIEWING INVISIBLE INDICIA; the disclosures of which are incorporated herein.

### FIELD OF THE INVENTION

This invention relates in general to security markers and in particular to security markers with adjustable sensor sensitivity control.

### BACKGROUND OF THE INVENTION

Inks have been used to mark items for a number of purposes, for example, for determining their authenticity or unique identification. Such markings, e.g., covert markings, may be used to identify goods that are intended for sale in a particular market. These markings are intended to prevent profit through the selling of goods for higher margins in a higher value market, where such goods were originally distributed for sale in a lower value market.

Covert marking applications typically require that the markings are both invisible to the human eye and difficult to reproduce in the event that the marking is discovered. Such marks can be produced through careful application of dyes that exhibit useful Stokes shifts when excited with a particular wavelength of light. UV dyes, for example, when excited with UV light will often emit a human detectable emission in the visible region.

Many lower cost materials that exhibit this phenomenon emit light in the blue region. This phenomenon may be useful, but has some serious drawbacks. Primarily, the ability to detect “UV marks” is quite easy because you only need a source of UV light (ubiquitous these days) and your eye, thus rendering the security of these marks as questionable. Secondarily, the effectiveness of blue emitting materials is limited, sometimes severely so if the substrate is white and has been treated with optical brighteners. Substrates treated with optical brighteners also emit blue light when excited with UV light thus making the contrast between substrate and mark difficult if not impossible to determine.

Infrared (IR) dyes have the benefit of excitation and emission in the infrared region. Without the aid of a carefully constructed viewing device, IR emission is not detectible to the human eye. A major drawback of these systems is that by their nature IR dyes are not particularly lightfast. Many efforts have been made to improve dye stability through dye structure manipulation and through favorable formulation development, i.e., inclusion of stabilization addenda.

It is known that inks for printing generally include a vehicle or solvent, a colorant (dye or pigment), a binder material (that affixes the colorant in place once the vehicle is adsorbed or evaporates) and other addenda that are specific to the printing methodology in use. In the case of solvent-based continuous inkjet printing, the vehicle may be a combination of organic solvents, the colorant (a dye or pigment depending on the equipment design and substrate requirements), a binder material (generally a polymer having sufficient solubility, viscosity, solvent release and binding properties), and conductivity improver (to enable sufficient charging of discrete ink droplets) and other addenda that enhance overall ink performance.

Polymethine (cyanine) dyes are one class of several possible classes that are nicely soluble in a variety of continuous inkjet printing systems and exhibit good fluorescence quantum yield. However most IR dyes, including polymethine dyes, are susceptible to undesired reactions leading to their possible depletion before an inks' desired lifetime has expired.

IR dyes are generally dark green to black when dissolved in solvent. It is a requirement that the dye be invisible to the eye when printed in the form of an ink (low or no stain). When printed, IR dyes can be visualized in an absorptive or emissive mode. Greater selectivity, and thus security, is enjoyed when the dyes are visualized in the emissive mode. This necessitates that the viewing device be constructed such that the excitation and emission wavelengths be sufficiently separated so that only the dye emission is detected and displayed. An additional requirement is that the dye be sufficiently diluted such that self quenching does not inhibit the emission process.

U.S. Pat. No. 5,093,147 discloses infrared fluorescing inks which are useful for printing invisible markings on the surface of an article. The inks use known polymethine (cyanine) laser dyes. Although the dyes used provide invisible markings, the cyanine dyes, unfortunately, have the disadvantage of fading or decomposing upon brief exposure to ultraviolet light.

It is known that near IR emissive dyes are susceptible to decomposition and that structural variation of the dye itself as well as the inclusion of protective addenda may lead to improved results. Said improvements are expensive and research intensive and do not completely eliminate dye fade. An apparative solution to mitigate the effects of dye fade through the design of the viewer is therefore desirable.

U.S. Pat. Nos. 7,712,667 and 7,516,899 disclose a hand held wireless reading viewer of invisible barcodes. It includes a display offering a live preview of the camera image. The intended function of this preview is only to find and center a non-human readable barcode. A microprocessor decodes the barcode and the result of the operation is the display and transfer of the barcode data.

U.S. Pat. No. 6,184,534 discloses a data reader and media bearing fluorescent indicia and the method of pulsing a light emitting diode. It is recognized that the fluorescent intensity of the dyes can be variable and it is suggested to pulse the light source with a current that is significantly higher than the steady state rated current in order to increase the amount of excitation light. The data reader is intended for decoding machine readable codes. It is shown positioned at a distance from the item with the fluorescent indicia with a substantial area of free space between the reader and the indicia. This allows ambient light to interfere with the signal from the fluorescent indicia.

U.S. Pat. No. 6,700,613 discloses a camera system for capturing both a visible and an invisible image. Like U.S. Pat. No. 6,184,534 the camera system is shown at a variable distance from the object without a means of excluding ambient light.

U.S. Pat. No. 7,357,326 discloses a fluorescent or luminescent optical symbol scanner intended for decoding a machine readable code. Exclusion of stray ambient light is important. This disclosure includes a shroud as part of the scanner. In order to realize the benefit of the shroud, however, the operator has to force the scanner onto the marked item.

U.S. Pat. No. 7,174,400 discloses thermal printing ribbons marked with an infrared fluorescent compound. For visualization of the markings, a hand held device is proposed where a camera is mounted inside a box above an opening at the bottom. Laser diodes are used to illuminate the sample and the image is viewed on a swivel monitor on top of the box.

None of the prior art recognizes that fading of the dye image is unavoidable and therefore additional measures are desirable to compensate for the fade of the dye using, for example, electronic means. The devices in the prior art are also commonly used to decode machine readable codes. An image preview function is only used to find the machine readable indicia, whereupon a microprocessor decodes the code. It is not recognized that human readable codes are an easier alternative in particular because they can be printed and read in a string that is wider than the field of view of the viewing device. Furthermore, the devices in the prior art are generally supported independently of the marked item, for example by holding a pistol grip-like manner, thus making it difficult to shield ambient light, in particular when the marked item lies flat.

### SUMMARY OF THE INVENTION

The present invention relates to a simple lightweight viewer for the visualization of human readable invisible indicia. It is constructed such that it rests on the marked item and offers a live preview image of the invisible indicia on a display on top of the viewer. One of the resting points of the viewer also functions as a shroud to block interference from ambient light. The invisible information can be alphanumeric strings. If the string is wider than the field of view of the viewer, the user can move the devices along the path of the string while reading the information on the display. For example, a printed name or code number can thus be compared to other visible information on the item, thus offering instant authentication. The viewer also comprises an electronic circuit to amplify or attenuate the image intensity based on the brightness of the invisible indicia. This circuit thus compensates for inevitable fading of the invisible indicia.

The invention and its objects and advantages will become more apparent in the detailed description of the preferred embodiment presented below.

### BRIEF DESCRIPTION OF THE DRAWINGS

FIG. 1 is a schematic view of the components of the viewer.

FIG. 2 is a schematic view of the viewer positioned on a marked item.

FIG. 3 is a plot of optical spectra of dye, light source, and filter.

FIG. 4 is a schematic view of the components of a variant of the viewer with light sources of different wavelengths.

FIGS. 5A-5C show images of light-faded samples imaged with and without brightness compensation.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

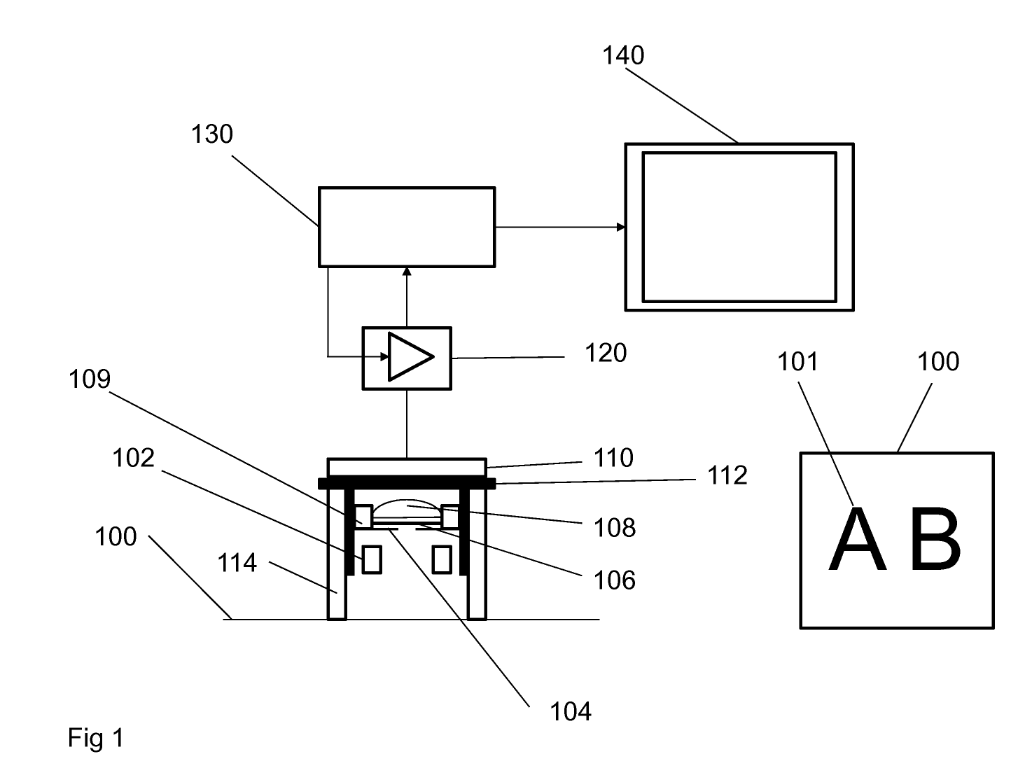

Referring now to FIG. 1 which shows the principal components of an imaging viewer suitable for viewing indicia printed with invisible infrared fluorescent inks A plurality of light sources 102 illuminate the surface of the marked media 100 with radiation of wavelength λₑₓ 1. The wavelengths are chosen such that they overlap with one or more absorption bands of the fluorescent dyes that comprise the infrared fluorescent ink. Light emitting diodes or laser diodes are suitable light sources. Upon excitation at wavelengths λₑₓ1, the fluorescent dyes emit radiation at wavelengths λₑₘ1. An imaging system comprising a circular aperture 104, filter 106, focusing lens 108, and array sensor 110 capture the image of the fluorescence of the printed indicia. The filter 106 serves to block the radiation of the light sources 100 while passing the emitted fluorescence radiation. The lens 108 focuses the fluorescence image onto the array sensor 110. The distance between the surface of the printed media and the lens can be adjusted using a focusing ring 112. A spiral grove in the focusing ring guides protrusions in a circular lens holder 109 and thereby translates the rotation of the focusing ring into a translational movement of the lens. The distance between the array sensor and the surface of the media is kept constant by way of a cylindrical baffle or spacer 114 of fixed length that surrounds the lens and light source. The baffle serves to block ambient light by way of an opaque outer surface. An inner white surface aids in diffusing the emitted radiation of the light sources. The array sensor 110 is of the CCD or CMOS type. The image is read out pixel-wise as a chain of voltages which are amplified by a variable amplifier stage 120. This amplifier can be physically integrated with the array sensor 110. The amplified image is digitized by a microcontroller 130. The digital image information is sent to a display 140 and the image is displayed at a rate that is equal to the rate of image capture. Typical values are 10-40 images/second. The microcontroller 130 analyzes each image and detects the image brightness in a region of interest. If the image brightness is larger or smaller than an expectation value, a correction signal is sent to the amplifier which adjusts the degree of amplification. For example, if the image is that of a severely faded fluorescent dye and is therefore less bright than the expectation value, the microcontroller increases the gain factor of amplifier 120 such that the next captured image is brighter. The relationship between image brightness and amplifier gain can be defined by a look up table. Alternatively, a proportional-integral-derivative (PID) control loop can be used.

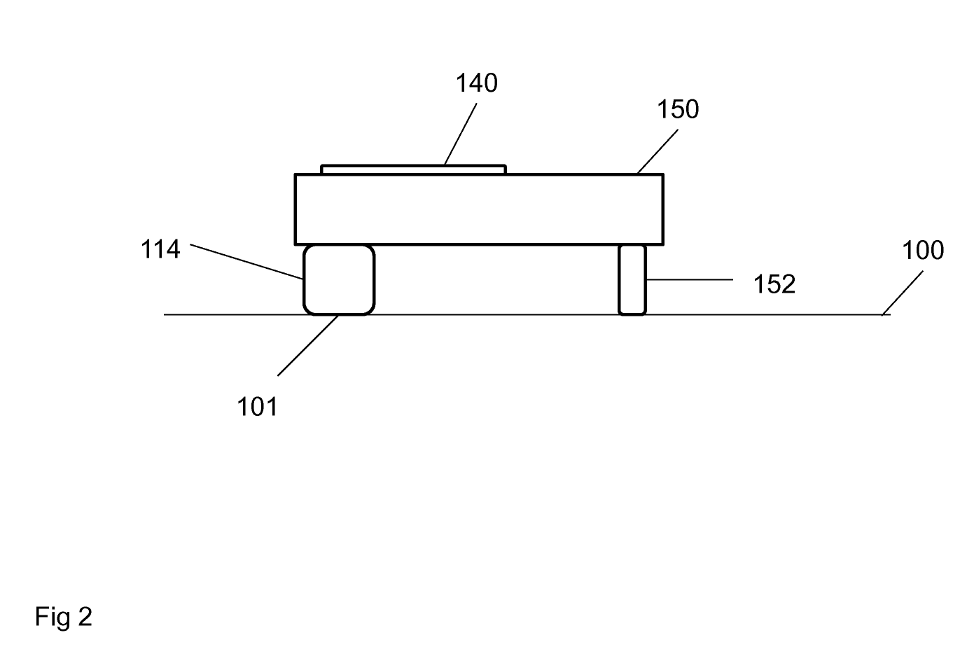

FIG. 2 shows a drawing of an imaging viewer suitable for viewing indicia printed with invisible infrared fluorescent inks For user convenience, the housing of the viewer 150 rests on the printed media 100 and is supported by the baffle 114 and feet 152. The image of the indicia printed using fluorescent inks is shown to the user on the display 140 at a position close to where the actual indicia 101 are printed on the surface of the media. If the size of the indicia is larger than the field of view of the viewer, for example when the indicia are a long string of alphanumeric characters, the user is able to drag the viewer over the region of printed indicia while simultaneously reading the information shown on the display. The viewer configuration is particularly advantaged for viewing information printed on a horizontal surface such as a document.

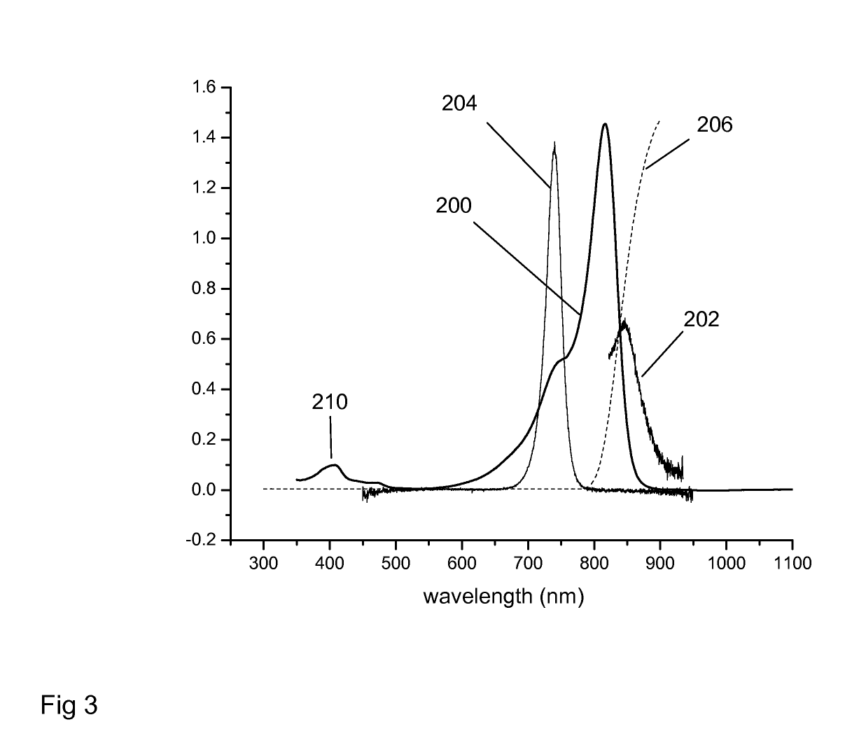

Suitable invisible inks for this invention are based on organic infrared dyes such as cyanines or phthalocyanines. FIG. 3 shows optical spectra of the dye absorption 200 and emission 202 of a prototypical dye, as well as the emission 204 of the light source 102, and the transmission curve 206 of the filter 106. Because of the large spectral overlap of the dye absorption and emission it is not possible to excite the dye in its absorption maximum while simultaneously capturing all of the dye emission. In order to block all of the excitation light from reaching the array sensor it is often necessary to excite the dye in the shoulder of the absorption at shorter wavelengths as well as to cut off some of the short wavelength component of the dye emission. This disadvantage can be overcome by exciting the fluorescent dye in the higher S2 excitation band instead of the lowest 51 excitation band. For the dye in FIG. 2 the S2 excitation band 210 is centered around 400 nm. Because of the large separation of dye excitation (400 nm) and dye emission (850 nm) one can easily design a filter that blocks all of the excitation light while transmitting all of the dye emission. For example, a long pass filter with a threshold wavelength of 700 nm could be chosen.

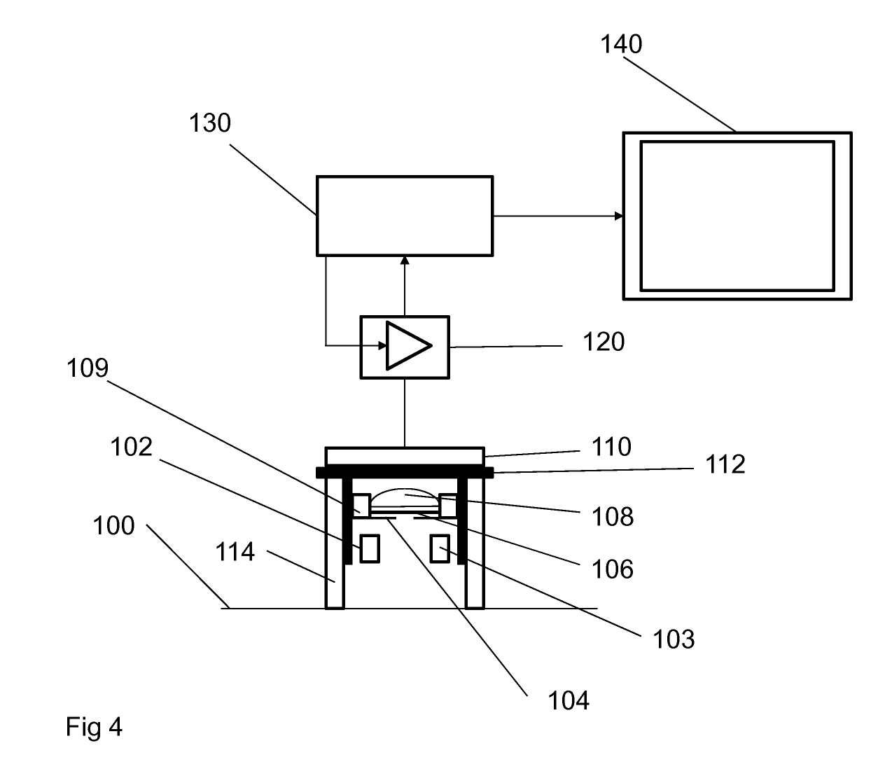

FIG. 4 shows a variant of the device in FIG. 1 wherein the light sources 102 and 103 emit light at the wavelengths λₑₓ1 and λₑₓ2, respectively. They can be independently turned on. λₑₓ1 is chosen to overlap with the absorption band of one of the dyes making up the infrared ink. The light of light source 102 is blocked by the emission filter 106. λₑₓ2 is chosen to overlap with the absorption band of a second dye. This light passes the emission filter. By alternating the light sources 102 and 103 the image can be switched from a fluorescence image of the first dye to a reflectance image of the second dye. When light source 102 is turned on and light source 103 is turned off, the dye image of the first dye is visible in the display as bright spots on a dark background. When light source 103 is turned on and light source 102 is turned off, the image of dye 2 is visible as dark features on a bright background. The ability of the device to visualize two invisible inks independently enables more complex security features on the printed media that are even harder to counterfeit.

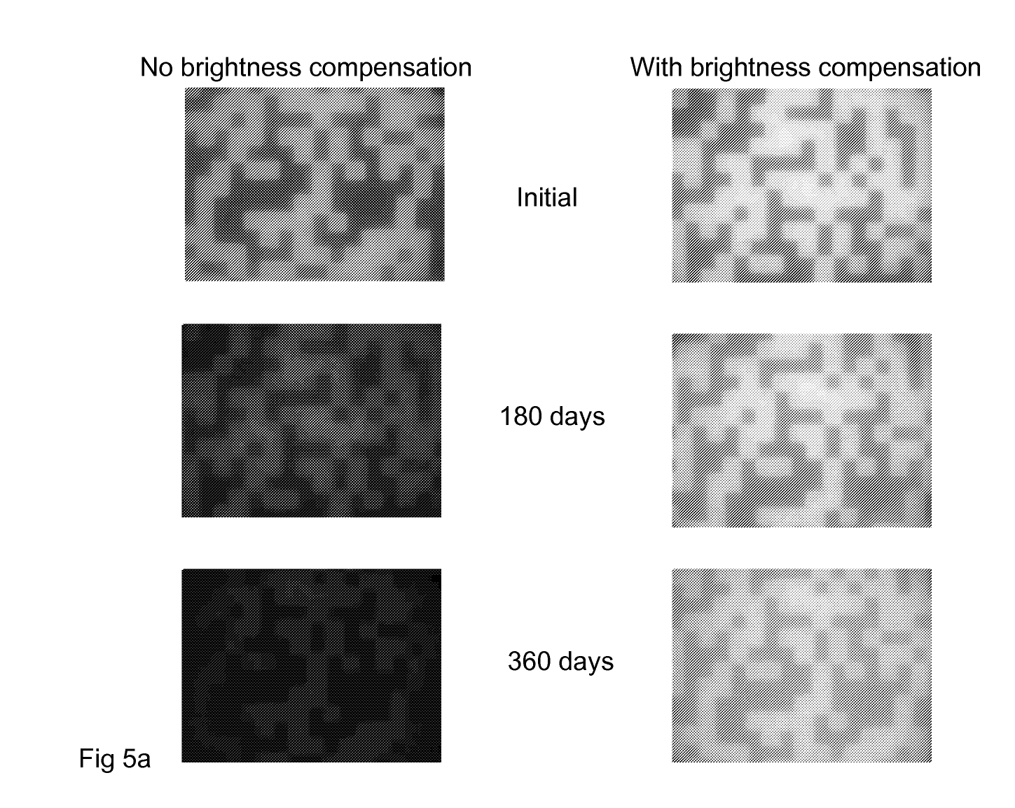

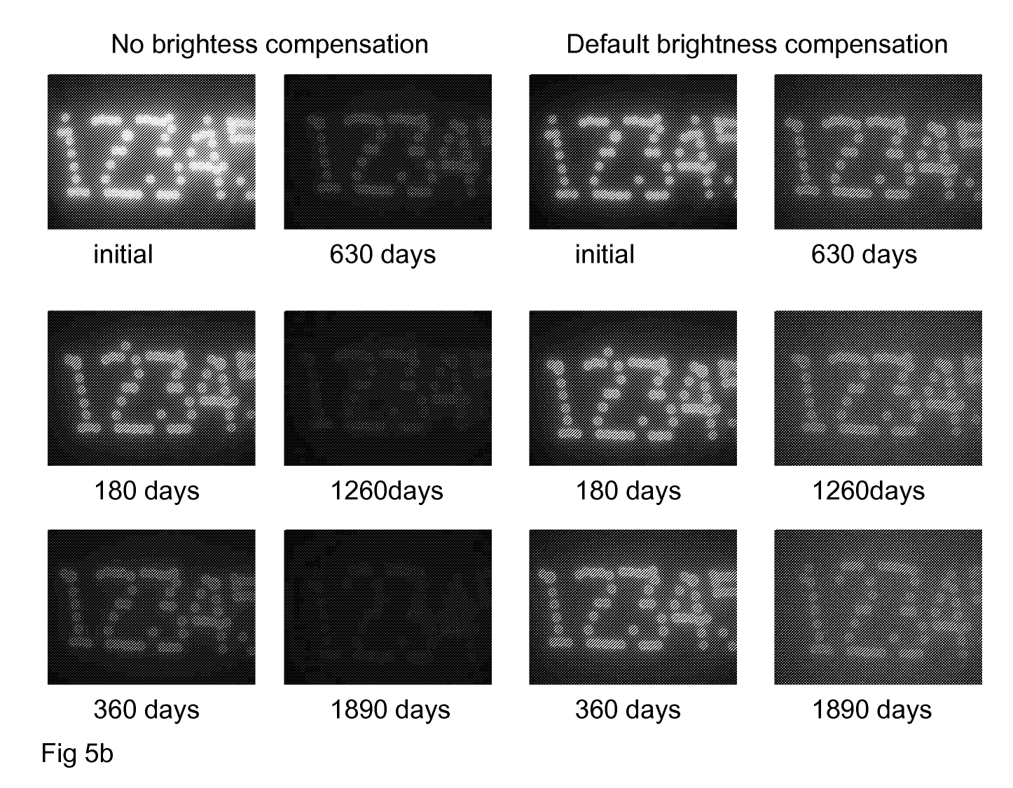

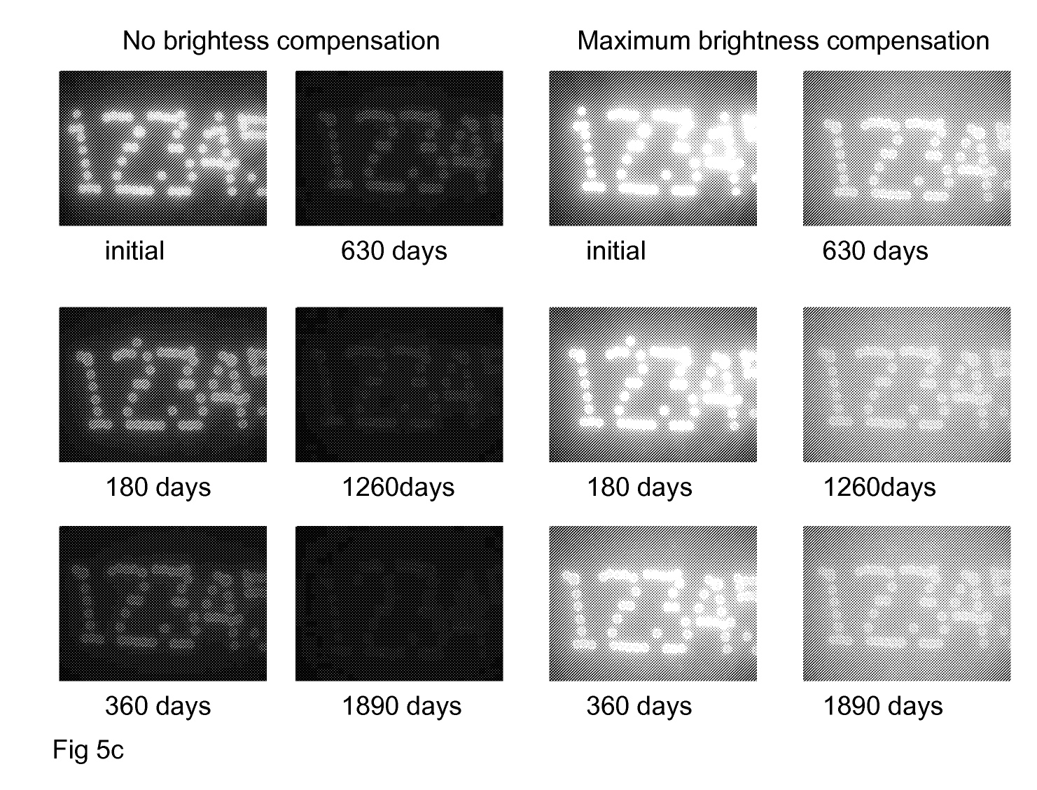

FIGS. 5A-5C show comparative examples of images of media printed with an invisible ink that were subject to accelerated light fade under conditions of 5.4 Klux daylight equivalent illumination. Under these conditions an exposure of 24 hours corresponds to an average exposure of 90 days under average room light conditions. The room light equivalent fade number is given underneath each image. The six images in the left half of the figure were imaged with a viewer without brightness compensation whereas the six images in the right half of the figure were imaged with a viewer that incorporates brightness compensation. Clearly, the brightness compensation affords much better readability of light faded samples.

The invention has been described in detail with particular reference to certain preferred embodiments thereof, but it will be understood that variations and modifications can be effected within the scope of the invention.

### PARTS LIST

100 surface of the marked media
101 printed indicia
102 light sources
104 aperture
106 filter
108 focusing lens
109 lens holder
110 array sensor
112 focusing ring
114 cylindrical baffle/spacer
120 amplifier
130 microcontroller
140 display
150 viewer housing
152 feet
200 dye absorption
202 dye emission
204 light source emission
206 transmission curve of filter
210 S2 excitation band of dye

1. An apparatus for detecting and viewing an invisible indicia comprising:
an illumination source for illuminating the invisible indicia with radiation of a first wavelength;
a sensor array for detecting emitted light from the invisible indicia at a second wavelength;
a filter between the sensor and the invisible indicia for eliminating reflected radiation at the first wavelength;
a lens for focusing an image of the invisible indicia on the sensor array;
a video display for displaying the image of the invisible indicia;
a spacer for spacing the sensor array at a fixed distance from the invisible indicia; and
a gain control for adjusting sensitivity of the sensor array.

2. The apparatus of claim 1 wherein the spacer is opaque.

3. The apparatus of claim 1 wherein the illumination source emits radiation in the infrared band.

4. The apparatus of claim 3 wherein the sensor detects radiation in the infrared band.

5. The apparatus of claim 1 wherein the illumination source emits radiation in the blue or ultraviolet band.

6. The apparatus of claim 5 wherein the sensor detects radiation in the infrared band.

7. The apparatus of claim 1 wherein the indicia is human readable by the apparatus.

8. An apparatus for detecting and viewing and invisible indicia comprising:
an illumination array for a illuminating the invisible indicia with radiation of a first and second wavelength;
a sensor array for detecting emitted light from the invisible indicia at least a third wavelength;
a filter between the sensor and the invisible indicia for eliminating reflected radiation at the first wavelength;
a lens for focusing an image of the invisible indicia on the sensor array;
a video display for displaying the image of the invisible indicia;
a spacer for spacing the sensor array at a fixed distance from the invisible indicia; and
a gain control for adjusting sensitivity of the sensor array.

9. The apparatus of claim 8 wherein illumination is alternated between the first and second wavelength.

10. The apparatus of claim 8 wherein illumination with the first wavelength generates a florescence image of the invisible indicia and illumination with the second wavelength generates a reflected image of the invisible indicia.

11. The apparatus of claim 8 wherein the apparatus is slid across a media.
